(19) United States
(12) Patent Application Publication
(10) Pub. No.: US 2009/0083612 A1
(43) Pub. Date: Mar. 26, 2009

(54) Method for processing electronic documents

(76) Inventor: Allen F. Baker, Evans, GA (US)

Correspondence Address: PATTON BOGGS, LLP, 2001 ROSS AVENUE, SUITE 3000, DALLAS, TX, 75201, US

(21) Appl. No.: 11/901,984

(22) Filed: Sep. 20, 2007

(51) Int. Cl. G06F 15/00

(52) U.S. Cl. 715/200

(57) ABSTRACT

The illustrative embodiments provide a method and computer usable program product for processing an electronic document. A process parses the document and identifies a set of first data components which may be located anywhere in the document. The process also identifies a relationship between two or more first data components and validates the relationship. The process transforms the document into a set of second documents and a subset of data components of the second documents into a third document. The various operations are performed in accordance with a set of rules. A rule for parsing includes a specification of a data component including data component's identifier and attribute, a directive to proceed to a second specification based on a condition, a rule identifier, and a directive to proceed to a second rule based on a second condition.

### BACKGROUND

1. Field of the Invention

The principles of the present invention relate generally to an improved data processing system, and in particular, to an improved document processing system. Still more particularly, the principles of the present invention relate to a method, apparatus, and computer-usable program product for analyzing, transforming, and processing electronic documents.

2. Description of the Related Art

Businesses exchange electronic documents with each other in order to conduct business transactions. For example, such electronic documents may include requests for product information, orders for products, invoices for sold goods and services, shipping notice, and confirmation of orders received.

For these and other similar purposes, many business transactions rely on electronic documents that have been standardized, such as by a standard description to include in a specific transaction for a specific industry. American National Standards Institute (ANSI) has developed standards for electronic documents used in a variety of business transactions under a specification called the X.12 specification. Similarly, the United Nations has promulgated a different set of standards for electronic documents under a standard called the United Nations Electronic Data Interchange for Administration Commerce and Transport (UNEDIFACT or UN-EDIFACT).

Parties, such as business organizations, often develop their own proprietary standards for the electronic documents they exchange with other parties, such as their business partners. These proprietary standards include specifications for electronic documents that may be based on a standard, such as ANSI X.12 or UN-EDIFACT standard, or may be a completely proprietary design.

Electronic documents conforming to a particular standard are usually referred to as a document of that standard. For example, an X.12 document is an electronic document that conforms to X.12 standards.

Electronic documents generally include information organized in some structure. The organization of that structure maybe specified by a standard, such as ANSI X.12. The organization of the structure may be specified in the document itself, such as an extensible markup language (XML) document.

Using X.12 documents as an example, the complete electronic document from start to finish is called a “document.” Within the organization of the document, data is organized in smaller organizations called “segments.” A piece of data in a segment is called a “data element.” Within a segment, data elements are arranged in a variety of ways.

Data elements may be separated from each other by specialized characters called “delimiters.” Alternatively, data elements may be separated from each other by fixed lengths of the data elements themselves. Segments are also separated from each other by delimiters or fixed lengths of the segments, just as data elements.

Data elements can be grouped together to form “composite data” within a segment. Segments can be grouped together to form a “transaction” within the document. Occasionally, several documents can be grouped together to form a “file” in a data transmission.

Software applications are used to facilitate the exchange of electronic documents between parties. These software applications primarily ensure that an electronic document is communicated to and is understandable by the intended recipient of that document. Such software applications are available as software products that a party can acquire and use for their own electronic document needs. Third parties also provide services based on such software applications, and a party can use such third-party services for exchanging electronic documents with another party.

### SUMMARY

The illustrative embodiments provide a method and computer-usable program product for processing an electronic document. The method may parse the document and identify a set of first data components forming the document. The process may also identify a relationship between two or more first data components in the set of first data components and validate the relationship. The process may transform the document into a set of second documents, such that each second document in the set of second documents uses a subset of the set of the first data components. The process may select a set of second data components from one or more of the set of second documents and generate a third document from the set of second data components. The process may then deliver the set of second documents and the third document to a set of destinations.

The process may also validate a subset of the set of the first data components. The document processed in this manner may be an X.12 document, where a first data component in the set of first data components is a data element of the X.12 document or a data segment of the X.12 document. A second document in the set of second documents may be an XML document, a document based on a transaction defined by a standard, or a document based on a transaction having a non-standard definition. The third document may be displayed to a user or reported in the form of a report.

The parsing, the identifying, the validating, the transforming, the selecting, and the generating may be performed in accordance with a set of rules. A rule for parsing in the set of rules may include a specification of a data component. The specification may include a data component identifier, a data component attribute, and a directive to proceed to a second specification of a second data component. The directive to proceed to the second specification of the second data component may be based on a condition. The rule may also include a rule identifier and a directive to proceed to a second rule. The directive to proceed to the second rule may be based on a second condition. The data component identifier and the rule identifier may each be a state in the processing of the document, and the directive to proceed to the second specification and the directive to proceed to the second rule may each be a state transition in the processing of the document. The data component associated with the data component identifier in a specification may be located anywhere in the document.

A rule for transforming in the set of rules may include an identification associated with the document, an identification associated with the second document, and logic for determining a number of second documents present in the set of second documents, and one or more attributes of each second document in the set of second documents. The attributes of each second document may include a type of the second document, a destination of the second document, or both.

A rule for sending in the set of rules may include an indication of a method of communication to use with the destination of the second document, a fourth document to send to a source of the document, a fifth document to receive from the destination of the second document, or a combination thereof. A rule in the set of rules may apply to any combination of the parsing, identifying, validating, transforming, selecting, and generating.

### BRIEF DESCRIPTION OF THE DRAWINGS

The novel features believed characteristic of the illustrative embodiments are set forth in the appended claims. The illustrative embodiments, however, as well as a preferred mode of use, will best be understood by reference to the following detailed description of an illustrative embodiment when read in conjunction with the accompanying drawings, wherein:

FIG. 1 depicts a block diagram of a data processing environment in which illustrative embodiments maybe implemented;

FIG. 2 depicts a block diagram of processing an electronic document in accordance with an illustrative embodiment;

FIG. 3 depicts a block diagram of the various configurations of the processing application in accordance with an illustrative embodiment;

FIG. 4 depicts a block diagram of a processing application in accordance with an illustrative embodiment;

FIG. 5 depicts a processing rule in accordance with an illustrative embodiment;

FIG. 6 depicts a flowchart of a process of processing an electronic document in accordance with an illustrative embodiment; and

FIG. 7 depicts a flowchart of the overall process of processing a document in accordance with an illustrative embodiment.

### DETAILED DESCRIPTION OF THE DRAWINGS

Electronic documents are organized in some structure according to a standard or definition. X.12 documents are organized into file, document, transaction, segment, composite data, and data element as described above. Electronic documents conforming to other standards or definitions may use different labels for each of these artifacts, but essentially organize data in the electronic document in the nested structure described above. The nested structure includes the largest organization of data where the largest organization of data includes one or more smaller organizations of data at one or more progressively inner levels in the electronic document, eventually including the actual data to be communicated at the lowest level.

For the clarity of the description below, the highest level of organization in an electronic document is called a “document”; a document may include zero or more “transactions”; a transaction may include zero or more “segments”; a segment may include zero or more “composite data” or “data element”; and a composite data including zero or more data elements. The terms used in the description of the illustrative embodiments below are consistent with the terms used for defining X.12 documents and are not intended to limit the illustrative embodiments to X.12 documents. These terms may represent a similar organization of data in any electronic document organized according to any standard or definition, whether from a standards body, proprietary, or a combination thereof. Accordingly, the illustrative embodiments may be used for processing any electronic document that uses a similar organization of data in the electronic document.

Illustrative embodiments recognize that existing applications for processing electronic documents (“existing applications”) use cumbersome software code and software techniques for processing the structures involved in the electronic document. For example, an existing application may use code for describing a transformation of an electronic document from one structural form to another. Such an application generally requires modification of code if an electronic document changes its organization at any level. For example, if the sender of an electronic document decides to change a certain piece of information in a data element in the electronic document, an existing application requires changes to the code and recompilation of the changed code in order to implement that change in the electronic document.

Illustrative embodiments further recognize that the manner in which existing applications process the document is an inefficient way of processing an electronic document. For example, an existing application may process an X.12 document, which is an electronic document based on the ANSI X.12 standard, sequentially from top to bottom. Consequently, if a party is interested in only a specific piece of information from the X.12 document, the application still must process the entire document before the application can provide that information of interest to the party. Furthermore, the existing application has to perform that processing sequentially, from the first segment to the last segment, in order, and from the first data element to last data element, again in order, for making any or all information contained in the electronic document available.

Therefore, an improved method and apparatus for processing electronic documents that removes or reduces the above-described inefficiencies in the existing applications are described herein. According to the illustrative embodiments, an electronic document can be analyzed or processed for any piece of information anywhere in the electronic document. In other words, in accordance with the principles of the present invention, an electronic document may be analyzed or processed in one or more segments without having to process the entire electronic document. Furthermore, an electronic document can be modified, and the illustrative embodiments altered, without extensive code changes to process the modified electronic document.

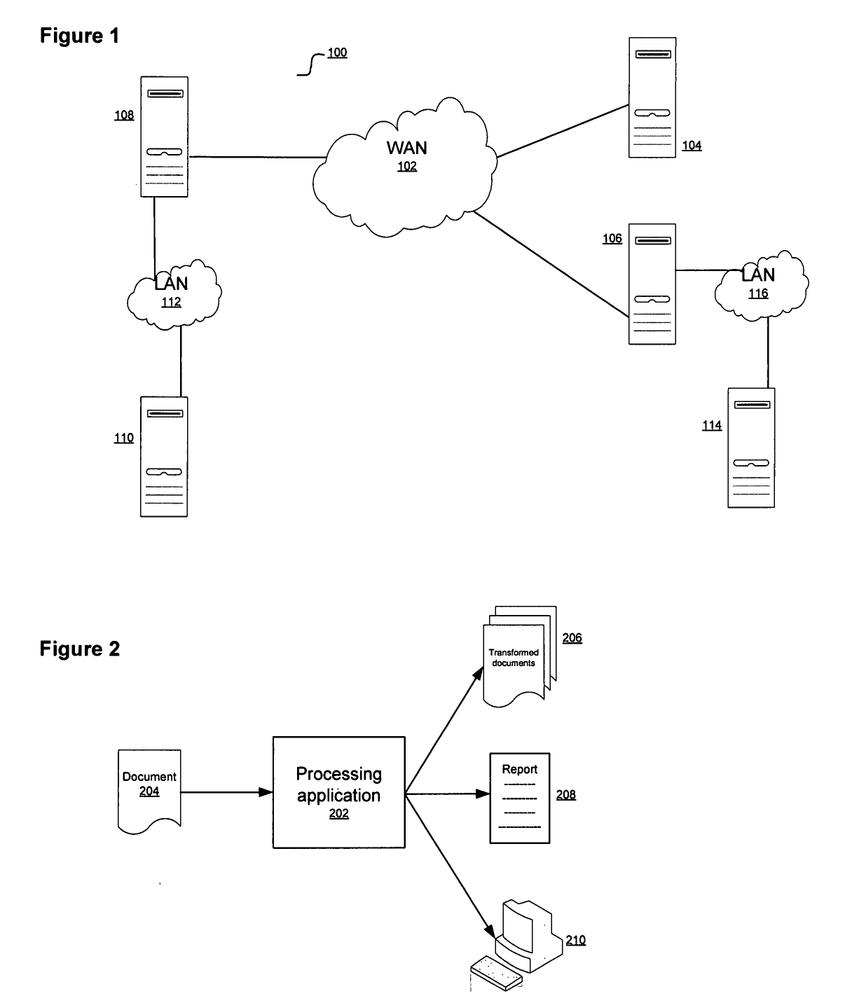

With reference to the figures, and in particular with reference to FIG. 1, an exemplary diagram of a data processing environment is provided in which illustrative embodiments may be implemented. FIG. 1 is not intended to assert or imply any limitation with regard to the environments in which different embodiments may be implemented. Many modifications to the depicted environments maybe made.

FIG. 1 depicts a block diagram of a data processing environment in which illustrative embodiments may be implemented. Data processing environment 100 includes wide area network (WAN) 102. A WAN, such as WAN 102, is a data network that spans large geographical areas, such as city blocks, cities, countries and continents, such that data processing systems located in those geographies may access the WAN 102. Typically, a commercial entity, such as an Internet service provider (ISP), operates or helps to operate the WAN 102. A WAN may provide interconnectivity to a large number, possibly tens of thousands, of data processing systems. A data processing system may be one or more devices capable of computing data.

Two or more data processing systems may be in communication with each other through WAN 102. FIG. 1 depicts computers 104, 106, and 108 being in communication with WAN 102, and consequently in communication with each other through WAN 102.

A local area network (LAN) is a data network generally smaller in size and scope than a WAN, providing interconnectivity to a smaller number of data processing systems than the WAN. Generally, LANs are limited to smaller areas, such as homes or offices, and may occasionally span areas larger than homes or offices. A WAN may connect several LANs and data processing systems with each other.

Data processing system 108 communicates with data processing system 110 over LAN 112. Similarly, data processing system 106 communicates with data processing system 114 over LAN 116. A data processing system's connectivity to a LAN or WAN may be wired or wireless. Additionally, a data processing system's connectivity to a LAN or WAN may be direct or through intermediate devices, such as through gateways, modems, switches, or other data processing systems. A data processing system may run software applications that perform a variety of functions. A software application may run on several data processing systems such that parts of the software application run on separate data processing systems. A software application running on several data processing systems in this manner is called a distributed application.

A data processing system, such as data processing system 108, may be a data processing system that is a source of an electronic document whereby that data processing system generates the electronic document. Another data processing system, such as data processing system 106, maybe a destination of the electronic document whereby that data processing system is the intended receiver of all or part of the information in the electronic document.

With reference to FIG. 2, this figure depicts a block diagram of processing an electronic document in accordance with an illustrative embodiment. Processing application 202 may be a software application running on a data processing system, such as data processing system 108 in FIG. 1. Processing application 202 may alternatively be a distributed application running on several data processing systems, such as on data processing system 102 and 108 across LAN 110 in FIG. 1.

Processing application 202 receives an electronic document which may include document 204. Processing application 202 processes document 204 such that one or more transformed documents 206 result from the processing. A transformed document is an electronic document including a document that may have different, less, or more data, or conform to a different structure than the document from a source, such as document 204. One or more transformed documents 206 may include part of the data in document 204, more or different data than the data in document 204, organized in same or different structure as in document 204.

Processing application 202 may also generate report 208. Report 208 may be a transformed document such as a transformed document in transformed documents 206. Report 208 may also include information from or about one or more documents, such as document 204 and/or one or more transformed documents 206. Report 208 may include additional information from an external source or computed information based on data in a document processed by processing application 202. These forms of report 208 are described only as exemplary and are not intended to be limiting on the illustrative embodiments. Other forms and contents of report 208 will be conceivable from this disclosure.

A party sending an electronic document, a party receiving an electronic document, or a third party may receive reports or perform analyses using processing application 202. Data processing system 210 represents any such party. Analysis using processing application 202 may be performed on an electronic document being processed, in any combination with archived data from previously processed electronic documents or in any combination with data from sources other than the electronic documents processed by processing system 202.

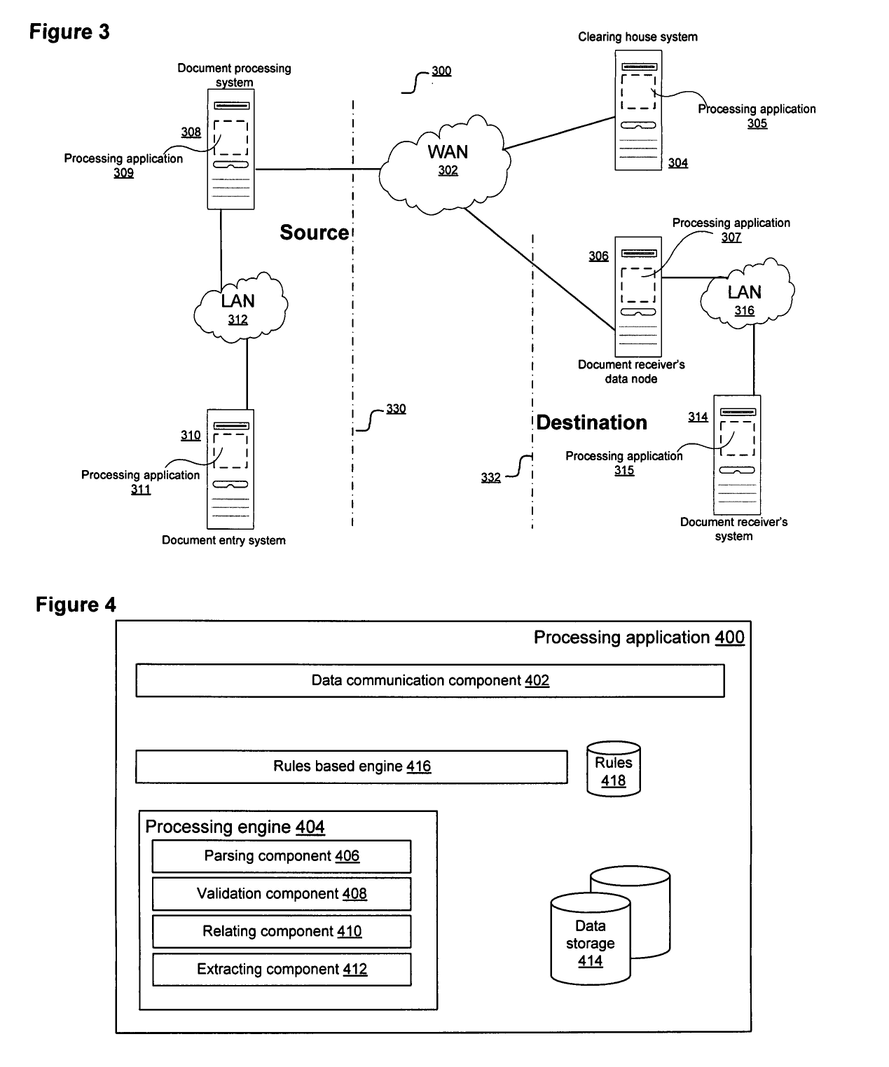

With reference to FIG. 3, this figure depicts a block diagram of the various configurations of an exemplary processing application in accordance with an illustrative embodiment. Data processing environment 300 may be implemented using data processing environment 100 in FIG. 1. WAN 302, data processing systems 304, 306, 308, 310, 314, and LANs 312 and 316 are arranged as described with respect to FIG. 1. Processing applications 305, 307, 309, 311, and 315 are each a possible location in data processing systems 304, 306, 308, 310, and 314, respectively, where a processing application, such as processing application 202, maybe configured.

In one embodiment, only one processing application from processing applications 305, 307, 309, and 315 may be configured in its corresponding data processing system to function in the manner of the illustrative embodiments described below. In such an embodiment, the configured processing application may perform all the processing of an electronic document to enable an exchange of the electronic document between parties.

In another embodiment, more than one processing application from processing applications 305, 307, 309, and 315 may be configured in their corresponding data processing systems. In such an embodiment, a processing system configured on a particular data processing system may perform only a portion of the processing of an electronic document. One or more other processing systems may perform other portions of the processing, thus completing the processing to enable an exchange of the electronic document between parties.

Demarcation line 330 illustrates an exemplary logical source side of data processing environment 300. Data processing systems 308 and 310 in this exemplary configuration are part of a source data processing system that may generate an electronic document, such as document 204 in FIG. 2. Similarly, demarcation line 332 illustrates an exemplary logical destination side of data processing environment 300. Data processing systems 306 and 314 in this exemplary configuration are part of a destination data processing system that may receive an electronic document, such as a transformed document from transformed document 206 in FIG. 2.

In one embodiment of such an exemplarily demarcated configuration, data processing system 310 may be a document entry system which may generate an electronic document. For example, a billing system that generates an invoice in the form of an electronic document may act as a document entry system, such as data processing system 310. The document entry system may include processing application 311 for generating the invoice.

In another embodiment of the exemplarily demarcated configuration, data processing system 308 may be a document processing system which may process an electronic document generated by a document entry system. For example, an invoice submitting system that creates an electronic document including several invoices consolidated from several billing entries entered in another system that may act as a document processing system, such as data processing system 308. The document processing system may include processing application 309 for converting billing entries into invoices.

In another embodiment, data processing system 304 may be a clearing-house system. A clearing-house system accepts an electronic document generated by one party's data processing system and processes the electronic document according to the needs of another party. For example, a clearing-house system may receive an electronic document including several invoices from a source, such as a medical services provider. The clearing-house system may transform the file into several electronic documents and send to different destinations, such as insurance payer companies. The clearing-house system may include processing application 305 for transforming the electronic document from the source to the electronic documents being sent to the destinations.

In another embodiment, data processing system 306 maybe a document receiver's data node system. A data node system, particularly a data node system within a destination party's infrastructure, is a data processing system that acts as a clearing-house system, but for only that destination party. A data node system may process an electronic document generated by one party's system according to the needs of the party that is the destination of that electronic document. A data node system may also monitor or facilitate the movement of data across various data processing systems, such as by buffering data for a period of time or while waiting for an event to occur, before sending the data to another data processing system. For example, a document receiver's data node system may receive an electronic document including an invoice. The document receiver's data node system may transform the electronic document into several pieces of information and send to different systems at the destination. The receiver's data node system may include processing application 307 for transforming the electronic document containing the invoice to the pieces of information being sent to the various systems at the destination.

A data node system may also act as a data interface between data processing systems using two different data formats. For example, acting in a clearing-house system type role, the data node system may translate data from one data processing system in one format into data to another data processing system in another format so that the two data processing systems may exchange data with each other.

In another embodiment, data processing system 314 may be one of the document receiver's data processing system which may process a piece of information sent to it by the receiver's data node system. For example, a document receiver's data processing system may receive an identifier for a patient who is named in an invoice. The document receiver's data node system may transform the identifier into patient information and perform other functions related to processing an invoice at the destination. The receiver's data node system may include processing application 315 for transforming the patient identifier into patient information at the destination.

The above embodiments are described only as exemplary and are not intended to be limiting on the illustrative embodiments. Many other configurations will be conceivable from this disclosure and are contemplated within the scope of the illustrative embodiments.

Furthermore, a particular embodiment may be a combination of any of the above-described embodiments or other embodiments conceivable from this disclosure. For example, in one embodiment, a data node system may also act as a document processing system, as described above with respect to data processing system 308, and vice-versa. In another embodiment, a data processing system may include functions of a document processing system, a clearing-house system, and a data node system, a document entry system, a document receiver's system, another data processing system, or any combination thereof.

With reference to FIG. 4, this figure depicts a block diagram of a processing application in accordance with an illustrative embodiment. Processing application 400 may be implemented using processing application 202 in FIG. 2, or any of processing applications 305, 307, 309, 311, or 315 in FIG. 3.

Processing application 400 includes data communication component 402. Data communication component 402 may provide data communication capabilities to processing application 400, such as for communicating with a WAN, such as WAN 302 in FIG. 3. Through providing such capabilities, data communication component 402 may receive electronic documents, transmit electronic documents, and support any other data communication needs of processing application 400.

Processing application 400 further includes processing engine 404. Processing engine 404 is one of the components of processing application 400 that manipulates the electronic documents processed by processing application 400.

Processing engine 404 includes parsing component 406, validation component 408, relating component 410, and extracting component 412. Parsing component 406 may identify an electronic document's data components and separate those data components out based on rules for parsing. Rules and handling of rules in processing application 400 are described in detail hereinbelow. For example, if the electronic document is an X.12 document, parsing component 406 may identify the various segments, composite data, data elements, or any combination thereof in that X.12 document. Any of the segments, groups of segments, composite data, and data elements can be a data component. A set of data components is zero or more data components.

Parsing component 406 may use a storage space, such as data storage 414, for storing the identified data components of the electronic document. Data storage 414 may be any type of storage suitable for storing data. For example, data storage 414 may be a relational database, an object-oriented database, a flat-file, an index-file, a structured file, or any other system or method of storing data.

Validation component 408 may validate the structure and contents of the various data components of the electronic document identified by parsing component 406 based on rules for validating. Continuing with the X.12 document example, validating component 408 may validate if a particular composite data is structured in accordance with the specification for that composite data. Validation component 408 may also validate whether a data element contains data of the type and size specified for that data element in the particular X.12 specification to which the electronic document purportedly conforms. Validation component 408 may perform other similar validations for X.12 and other types of electronic documents.

Additionally, validation component 408 may reference or communicate with external sources of information for the validation of data components. For example, a table in data storage 414 may contain the valid values for a specific data component. If validation component 408 encounters that specific data component during validation, validation component 408 may reference the table to determine if the value contained in the specific data component is valid. Such referencing of external sources may be useful in many instances, for example, when the values in data components are subject to change.

Relating component 410 may identify, draw, or form relationships amongst the various data components of an electronic document as identified by parsing component 406 based on rules for identifying and rules for relating. Identifying, drawing, or forming relationships amongst the various data components of an electronic document may enable a better understanding of the electronic document than the understanding of the electronic document without these functions.

For example, in an X.12 document, there may be several billing transactions directed to a common payer. These transactions can be related to each other, to wit, a relationship amongst these billing transactions can be identified based on the commonality of the payer in each of these transactions. By identifying or drawing this relationship in this manner, several additional analyses of the electronic document become possible. For example, a report can be generated according to a rule for generating in addition to processing the electronic document for actually presenting an invoice to the payer. The report can show from whom, for which patient, how many, and what types of billing items the payer has received in that electronic document.

As another example, a particular segment may relate to another segment in the document if a certain value is present in the latter segment. For example, if a segment identifies a payer name, another related segment may identify a payment address. Thus, the two segments may be related to each other through the presence of the payer's name in this example. Many other relationships may exist in electronic documents and can be similarly processed using the illustrative embodiments.

In one embodiment, relating component 410 may perform these functions after validation component 408 has performed its functions. In another embodiment, relating component 410 may perform these functions before validation component 408 has performed its functions. In another embodiment, relating component 410 may perform these functions simultaneously while validation component 408 is performing its functions.

Extracting component 412 is a tool that can select, extract, transform, or present specified data from an electronic document based on rules for selecting, rules for extracting, and rules for transforming. For example, a parsing component may identify several data elements in an X.12 document. Some of these data elements may be names of patients in a medical invoice; other data elements maybe names of payers, dates of service, and places of service. Extracting component 412 may be instructed via rules to select address information of a payer with a specific name for services performed at a specific place of service. Extracting component 412 may be further instructed to transform the address into a form that is different from the form in which the address is presented in the electronic document.

As another example, extracting component 412 may select a specific data element identified in an electronic document by parsing component 406 and assign it a label or name such as “provider name.” By so assigning, extracting component 412 can look for the same data element in other similar electronic documents and present the data contained therein as the name of the provider of the services identified in those other electronic documents. The processes of assigning a label, extracting information, and transforming information, as in the examples above, are processes related to one or more of creating a rule, modifying a rule, and executing a rule for extracting component 412, such as a rule for selecting, a rule for extracting, or a rule for transforming.

The above-described components of processing engine 404 are described only as exemplary for the clarity of the functioning of processing engine 404. These components are not intended to be limiting on the illustrative embodiments and may be combined, modified, reorganized, or enhanced according to the needs of a particular implementation. For example, in one embodiment, the functions of validating component 408 may be combined with the functions of parsing component 406 to result in a single component that acts as parsing component 406, as well as validating component 408.

As another example, in another embodiment, parsing component 406 and extracting component 412 may be combined to identify specific data in an electronic document from a source, label that data, transform that data and present that transformed and labeled data into another electronic document for a destination.

Processing application 400 further includes rules-based engine 416. Rules-based engine 416 is a component that can be invoked by other components to execute rules. In one embodiment, rules-based engine 416 may not be a separate component as depicted in FIG. 4, but is included in other components that use rules. For example, in one embodiment using this form of rules-based engine 416, parsing component 406 may include rules-based engine 416.

Rules may be stored in a data storage, such as rules 418. Rules 418 is a data storage for rules, and may or may not be separate from data storage 414. As an example, extracting component 412 may invoke rules-based engine 416 to execute a rule for extracting from rules 418. The rule for extracting when executed by rules-based engine 416 may enable extracting component 412 to extract a specific data element identified in an electronic document by parsing component 406, and assign it a label “provider name” as described above.

Rules 418 may include a variety of rules. As in the examples above, a rule for parsing may assist in the parsing function of parsing component 406. For example, a rule for parsing pertaining to healthcare claims in an X.12 837 healthcare claim document (“837 document”) may assist parsing component 406 in traversing the 837 document and identifying the various data components of the 837 document.

Similarly, a rule for extracting may assist in the extracting and labeling function of extracting component 412. A rule for identifying may be a rule that helps parsing component 406 in identifying the various data components of a specific electronic document. A rule for validating may assist validating component 408 in validating some data components of an electronic document. A rule for validating may also assist in validating a relationship between data components.

A rule for relating may help relating component 410 in identifying relationships amongst data components of an electronic document based on a certain criterion. A rule for transforming may help extracting component 412 in transforming an extracted data into another form. A rule for selecting may help extracting component 412 in selecting certain data for extraction. A rule for generating may help extracting component 412 in generating a report or another document using some extracted data.

A rule may assist in one or more functions of one or more components. For example, a rule may be a parsing rule, as well as a validating rule in that different instructions in the same rule may help parsing component 406 in parsing and validating component 408 in validating.

These examples of the various rules are described above to show the various types of rules that are possible for use with the described components of processing application 400. These examples further describe the variety of functions in which these types of rules can assist. However, these examples of the various rules are not intended to be limiting on the illustrative embodiments. Many other rules will be conceivable from these examples and associated descriptions. Additionally, rules may be combined, new rules and rule types may be created, and some of the above-described rules and rule types maybe omitted in specific implementations.

Furthermore, the examples of processing an 837 document are used only for the clarity of the description and are not limiting on the illustrative embodiments. Any electronic document may be processed using processing application 400 in the same or similar manner.

Note that these components, rules, and processing functions are described only as exemplary components of processing application 400. These components, rules, and processing functions are not intended to be limiting on the illustrative embodiments. Many other new components, rules, and processing functions, or combinations of the same will be apparent from this disclosure.

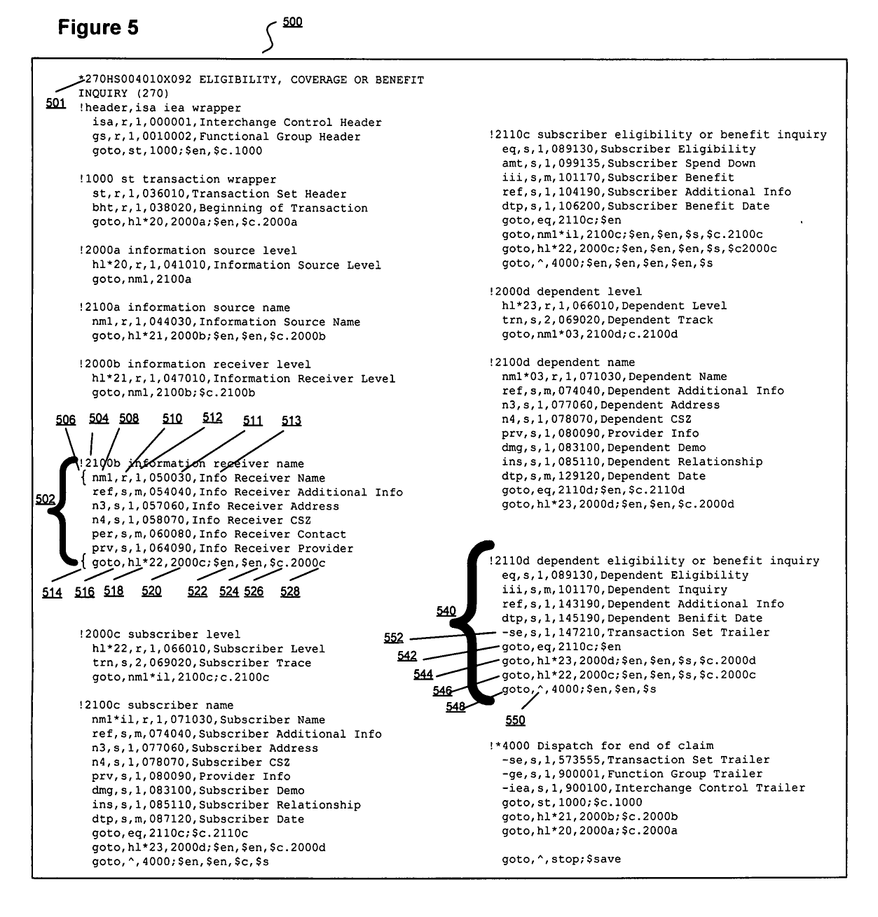

With reference to FIG. 5, a processing rule is depicted in accordance with an illustrative embodiment. Rule 500 may be implemented as a rule in rules 418 in FIG. 4. Rule 500 may be executed by rules-based engine 416. Rule 500 may be used parsing component 406 in processing engine 404 of processing application 400 in FIG. 4.

Rule 500 is an exemplary processing rule that may be used in the illustrative embodiments for processing an exemplary X.12 version 4010 270 document that pertains to an eligibility and coverage of benefits inquiry in the healthcare industry. A processing rule, such as rule 500, may be a rule for parsing and may be used for parsing an electronic document. The rule 500 may contain processing information about various data components of the electronic document. For example, rule 500 contains processing information about groups of segments that constitute the X.12 270 document according to a corresponding specification in the ANSI X.12 specifications. Rule 500 may be identified by rule identifier 501 which is an unique identifier for rule 500 within the scope of a processing application.

Each group of segments described in this manner is called a loop. Loop 502 is an example of processing instructions for a loop in the 270 document.

Using loop 502 as an example for illustrating the functioning of the processing instructions in rule 500, each loop is identified by a loop identifier, such as loop identifier 504, which in the case of exemplary loop 502, has the value “2100b.” Informative text can be added after a space or another delimiter following loop identifier 504. Such information may be ignored in processing or may be used for specific processing functions, for example, for inserting comments in a processing log.

Loop 502 next lists processing instructions for the various segments that the specification specifies for that loop. For example, according to the X.12 version 4010 specification for a document of type 270, segment 506 should be the first segment to occur in loop 502. A segment that is identified in a loop, such as segment 506 in loop 502, may have a segment identifier, such as segment identifier 508 which, in the exemplary loop 502, is the string “nm1.” Note that a segment identifier is a data component identifier and may be any string in a segment or data component at a known location. For example, a segment identifier may include the first and second data elements in the segment and may further include the delimiter between the first and the second data elements. For example, instead of “nm1,” segment identifier 508 may have a value of “nm1*21,” which includes “nm1,” the segment identifier according to X.12 standards, and “21” which is the first data element—entity identifier code—identifying an entity with a two digit code. “*” is the delimiter that separates the segment identifier and the entity identifier code data element in this example.

A segment may be mandatory or required, or optional or situational. Exemplary segment 506 includes usage indicator 510 which may have a value of “r” for required and “s” for situational. A segment may repeat a number of times in a loop. An occurrence indicator indicates how many times a segment may repeat in a loop. Exemplary segment 506 includes occurrence indicator 512, whose value in this example is “1,” indicating that segment “nm1” may occur exactly once in loop “2100b.”

Informative text can be added after a space or another delimiter following occurrence indicator 512. Such information may be ignored in processing or may be used for specific processing functions, for example, for inserting comments in a processing log. Reference number 511 is a unique identifier associated with segment 506 that may be used as informative or for other purposes as described here. Segment name 513 is a plain text name associated with segment 506 that may also be used as informative or for other purposes.

Additional instructions for processing of a particular segment may be added in place of the informative text. For example, data elements may be specified by type, nature, usage, repetition, content, or size in order to process a segment's constituent data elements before progressing to the next segment in the loop.

Once instructions for processing a data component of the electronic document are complete, the instructions may include a directive to perform a next function, such as to proceed to other instructions for processing other data components of the electronic document. For example, when the segments for loop 502 are defined, loop 502 may include a directive to proceed to another loop. In the exemplary loop 502, directive 514 includes action 516. Action 516 in this case is “goto” which is an instruction to proceed to another loop. Action 516 maybe contingent upon one or more conditions.

Here, action 516 is shown to depend on condition 518. Condition 518 here is a segment identifier “h1*22” which indicates that the action 516 “goto” should be performed when the next segment after the segments listed in loop 502 has a segment identifier “h1*22.” Target 520 in this example is a loop identifier of a loop whose instructions should be processed next. Here, target 520 has a value “2000c.” Thus, exemplary directive 514 in this exemplary loop 502 indicates that the processing of exemplary X.12 270 document should proceed from loop identifier “2100b” to loop identifier “2000c” if the segment following segments of loop “2100b” has segment identifier “h1*22.”

Many other instructions for processing an electronic document can be included in the rule according to the illustrative embodiment described above. For example, rule 500 may be creating a translated document as it analyzes an electronic document containing a 270 document. The translated document may be an XML document. Exemplary loop 502 includes instructions for creating and structuring the translated document.

For example, switch 522 has a value “$en.” The switch may be an instruction to end the current level of XML structure in the XML document where the information from the 270 document is being inserted. Switch 524 also has a value “$en” and maybe an instruction to end the parent level of the current level XML structure in the XML document where the information from the 270 document is being inserted. Thus, in a particular rule according to the illustrative embodiment, any number of levels can be terminated by having multiple switches, such as switches 522 and 524. Other instructions can intervene between switches 522 and 524.

As another example, switch 526 has a value “$c.” This switch maybe an instruction to clear the information about the current loop that is being processed in the X.12 270 document. Such a switch maybe useful when processing a document is nested several levels deep and needs to end for a new loop that begins after those levels. Switch 526 has tag 528 with value “2000c.” Switch 526 and tag 528 are separated by a delimiter, in this exemplary case, a . “ . . . ” Tag 528 may be the instruction about which loop to end by processing switch 526.

Furthermore, a loop may include multiple actions. For example, loop 540 is shown to include four actions 542, 544, 546, and 548. Multiple actions in a loop may be alternative actions, and anyone of them may execute depending on which action's condition is true.

In exemplary loop 540, action 542 is “goto” which is an instruction to proceed to another loop. Action 542 may be contingent upon one or more conditions. Here, action 542 is shown to depend on the condition that when the segment identifier of the next segment is “eq,” the processing should proceed to the target loop identified by the loop identifier having a value “2110c.” Thus, exemplary directive 542 in this exemplary loop 540 indicates that the processing of exemplary X.12 270 document should proceed from loop identifier “2110d” to loop identifier “2110c” if the segment following segments of loop “2110d” has segment identifier “eq.” Switch “$en” functions as described above.

Similarly, exemplary directive 544 in this exemplary loop 540 indicates that the processing of exemplary X.12 270 document should proceed from loop identifier “2110d” to loop identifier “2000d” if the segment following segments of loop “2110d” has segment identifier “h1*23.” The switches at the end of action 544 function as described above.

Similarly, exemplary directive 546 in this exemplary loop 540 indicates that the processing of exemplary X.12 270 document should proceed from loop identifier “2110d” to loop identifier “2000c” if the segment following segments of loop “2110d” has segment identifier “h1*22.” The switches at the end of action 546 function as described above.

Exemplary directive 548 in this exemplary loop 540 indicates that the processing of exemplary X.12 270 document should proceed from loop identifier “2110d” to loop identifier “2000d” if the segment following segments of loop “2110d” has not matched any of the conditions in the preceding actions, to wit, actions 542, 544, and 546. Action 548 depends on condition 550 that has an exemplary value “̂”. A particular implementation of rule 500 may use the “̂” value or any other suitable value in condition 550 to indicate that the processing should follow action 548 when the previous conditions of the previous actions have been found to be false. This condition can be the default condition that may always be true to provide an exit from the current loop being processed. Here, action 548 instructs the processing to proceed to loop with loop identifier “4000.” The switches at the end of action 544 function as described above.

Additionally, certain segments in a loop may be identified in the manner of segment 552. Segment 552 includes a segment identifier ”-se.” The sign ”−” at the beginning of the actual segment identifier “se” may indicate that the segment may be encountered in the present loop during processing. The sign ”−” or another suitable indication may indicate the processing to ignore the statement, accept the statement without validating, or provide an alternative processing. In this manner, certain segments may be identified to be processed differently than other segments in the loop.

Thus, exemplary rule 500 is designed process an X.12 version 4010 document 270. A processing rule may be designed according to the illustrative embodiments to process any electronic document. Such processing rule according to the illustrative embodiments may proceed by identifying a data component of the electronic document as a loop with a group of segments. The processing rule may include a specification of the data component by including one or more data component attributes, such as constituent segments, constituent data elements or a constituent group of segments with their constituent data elements. The specification may further include one or more directives, a directive being based on one or more conditions for subsequent processing.

By executing a rule according to the illustrative embodiments as described above, the structure of an electronic document may be verified and the content parsed out. Using the structural information and the parsed out contents of the electronic document, another rule, or additional instructions in the same rule, can perform additional functions. For example, a rule for validating may validate the parsed out content; a rule for relating may relate data components.

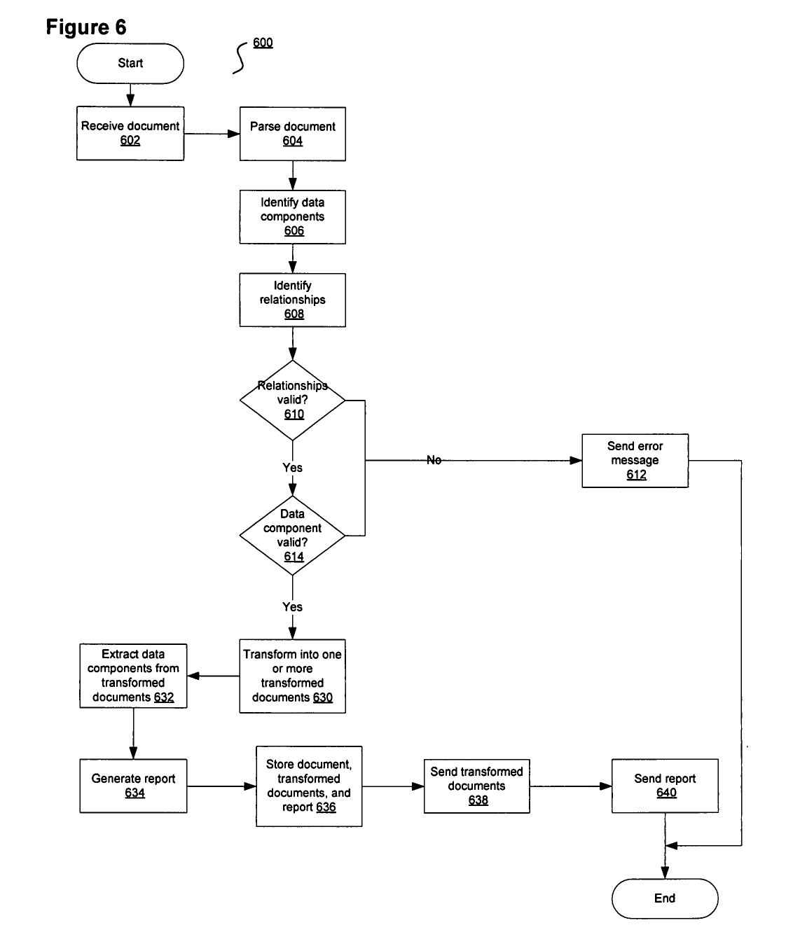

With reference to FIG. 6, this figure depicts a flowchart of a process of processing an electronic document in accordance with an illustrative embodiment. Process 600 may be implemented in processing application 400 in FIG. 4.

Process 600 may receive an electronic document including one or more documents. The process begins by receiving a document (step 602). The process parses the document (step 604). The process identifies zero or more data components included in the document (step 606). The process identifies relationships between two or more data components identified in step 606 (step 608). Note that steps 604, 606, and 608 are depicted in that order only as exemplary, but may be performed in any order depending on the specific implementation of the illustrative embodiments.

The process determines whether the relationships identified in step 608 are valid (step 610). If one or more relationships are not valid, (“No” path of step 610), the process may send an error message, such as to a source of the document received in step 602 (step 612). The process may end thereafter.

Returning to step 610, if the relationships identified in step 608 are valid, (“Yes” path of step 610), the process determines if the data components are valid (step 614). Note that a specific implementation may be able to proceed to step 614 from the “No” path of step 610, even if one or more relationships identified in step 608 are not valid, such as by making additional determinations.

If one or more data components are not valid, (“No” path of step 614), the process may send an error message, such as to a source of the document received in step 602 (step 612). The process ends thereafter. If, however, the data components are valid, (“Yes” path of step 614), the process transforms the document (step 630). Note that a specific implementation may be able to proceed to step 630 from the “No” path of step 614, even if one or more data components are not valid, such as by making additional determinations. In one embodiment, process 600 may end after step 630.

However, FIG. 6 depicts additional steps that may be incorporated in process 600. For example, process 600 may extract one or more data components from one or more transformed documents generated in step 630 (step 632). Process 600 may use the extracted data components to generate a report (step 634).

Process 600 may also perform other optional functions. For example, the process may store the document received in step 602, one or more transformed documents, and the report (step 636). Furthermore, the process may perform step 636 before sending either the transformed documents or the report. As FIG. 6 depicts, in one embodiment, process 600 may then send the transformed documents to their respective destinations (step 638). The process may send the report to its destination (step 640). The process ends thereafter. In another embodiment, the sending of the transformed documents and the report may occur simultaneously with or before the storing of step 636.

Additionally, process 600 may accept documents from various destinations in return for sending the transformed documents. For example, a destination may send back an acknowledgment for a transformed document it receives, or it may send a document containing information responsive to the information in the transformed document. Process 600 may receive such documents from one or more destinations, including the destination of the report. Furthermore, process 600 may itself generate and send documents to the source of the original document, such as for acknowledging receipt of the original document.

Note that the steps of process 600 are selected and described only for clarity of the description and are not limiting on the illustrative embodiments. Depicted steps may be combined, further divided, augmented to, deleted, or modified in particular implementations.

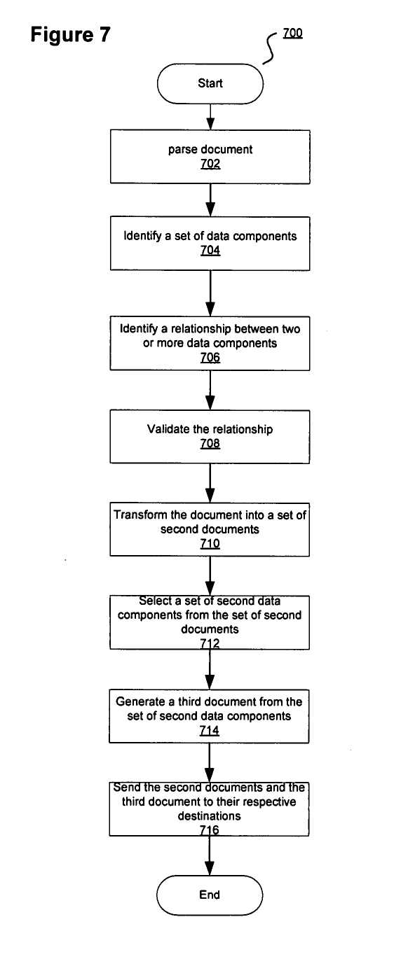

With reference to FIG. 7, this figure depicts a flowchart of the overall process of processing a document in accordance with an illustrative embodiment. Process 700 may be implemented in processing application 400 in FIG. 4.

Process 700 begins by parsing a document (step 702). A set of data components is identified (step 704). One or more relationships between two or more data components is identified (step 706). The identified relationships are validated (step 708). The document is transformed into a set of second documents or transformed documents (step 710). A second set of data components is selected from the set of second documents (step 712). A third document, such as a report, is generated from the selected data components (step 714). The set of second documents and the third document are sent to their respective destinations (Step 716). The process ends thereafter.

Thus, in the illustrative embodiments described above, a computer implemented method, apparatus, and computer program product provide for processing electronic documents. The illustrative embodiments describe a processing application, including a processing engine that parses the electronic documents into its data components, validates, relates, and transforms the electronic documents and its data components, and extracts data components from transformed documents into other types of documents. The method, apparatus, and computer-usable program product of the illustrative embodiments present a method of parsing, validating, relating, transforming, and extracting electronic documents that may reduce or remove the shortcomings associated with the presently used methods for processing electronic documents.

For example, using the illustrative embodiments, an electronic document need not be analyzed, parsed, or validated sequentially from top to bottom. If a party is interested in only a specific piece of information from an electronic document, the illustrative embodiments can provide that information of interest to the party without having to process the entire document by suitably configuring the rules for parsing, the rules for validating, the rules for relating, the rules for extracting, and other types of rules as needed. Thus, the illustrative embodiments may make any and all information contained in an electronic document available without processing the electronic document from the first segment to the last segment, in order, and from the first data element to last data element, again in order.

The illustrative embodiments can take the form of an entirely hardware embodiment, an entirely software embodiment, or an embodiment containing both hardware and software elements. Furthermore, the illustrative embodiments can take the form of a computer program product accessible from a computer-usable or computer-readable medium providing program code for use by or in connection with a computer or any instruction execution system. For the purposes of this description, a computer-usable or computer-readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read-only memory (CD-ROM), compact disk-read/write (CD-R/W) and DVD.

Further, a computer storage medium may contain or store a computer-readable program code such that when the computer-readable program code is executed on a computer, the execution of this computer-readable program code causes the computer to transmit another computer-readable program code over a communication link This communication link may use a medium that is, for example without limitation, physical or wireless.

The above description has been presented for purposes of illustration and description and is not intended to be exhaustive or limited to the illustrative embodiments in the form disclosed. Many modifications and variations will be apparent to those of ordinary skill in the art.

What is claimed:

1. A method for processing a document, the method comprising:
parsing the document;
identifying a set of first data components forming the document;
identifying a relationship between two or more first data components in the set of first data components;
validating the relationship between the two or more first data components;
transforming the document into a set of second documents, each second document in the set of second documents using a subset of the set of the first data components;
selecting a set of second data components from one or more of the set of second documents;
generating a third document from the set of second data components; and
delivering the set of second documents and the third document to a set of destinations.

2. The method of claim 1, further comprising:
validating a subset of the set of the first data components.

3. The method of claim 1, wherein the document is an X.12 document, wherein a first data component in the set of first data components is one of a data element of the X.12 document and a data segment of the X.12 document.

4. The method of claim 1, wherein a second document in the set of second documents is one of an XML document, a document based on a transaction defined by a standard, and a document based on a transaction having a non-standard definition.

5. The method of claim 1, wherein the third document is one of displayed to a user and reported in the form of a report.

6. The method of claim 1, wherein the parsing, the identifying, the validating, the transforming, the selecting, and the generating is performed in accordance with a set of rules.

7. The method of claim 6, wherein a rule for parsing in the set of rules comprises:
a specification of a data component, the specification including:
a data component identifier;
a data component attribute; and
a directive to proceed to a second specification of a second data component.

8. The method of claim 7, wherein the directive to proceed to the second specification of the second data component is based on a condition.

9. The method of claim 7, wherein the rule further comprises:
a rule identifier; and
a directive to proceed to a second rule.

10. The method of claim 9, wherein the directive to proceed to the second rule is based on a second condition.

11. The method of claim 9, wherein each of the data component identifier and the rule identifier is a state in the processing of the document, wherein each of the directive to proceed to the second specification and the directive to proceed to the second rule is a state transition in the processing of the document.

12. The method of claim 6, wherein a data component associated with the data component identifier in a specification maybe located anywhere in the document.

13. The method of claim 6, wherein a rule for transforming in the set of rules comprises:
an identification associated with the document;
an identification associated with the second document; and
a logic, wherein the logic is usable for determining a number of second documents present in the set of second documents, and one or more attributes of each second document in the set of second documents.

14. The method of claim 13, wherein the attributes of each second document include one or more of a type of the second document and a destination of the second document.

15. The method of claim 6, wherein a rule for sending in the set of rules comprises one or more of an indication of a method of communication to use with the destination of the second document, a fourth document to send to a source of the document, and a fifth document to receive from the destination of the second document.

16. The method of claim 6, wherein a rule in the set of rules may apply to any combination of the parsing, identifying, validating, transforming, selecting, and generating.

17. A computer usable program product in a computer readable medium storing computer executable instructions for processing a document that, when executed, cause a data processing system to:
parse the document;
identify a set of first data components forming the document;
identify a relationship between two or more first data components in the set of first data components;
validate the relationship between the two or more first data components;
validate a subset of the set of the first data components;
transform the document into a set of second documents, each second document in the set of second documents using a subset of the set of the first data components, and wherein a second document in the set of second documents is one of an XML document, a document based on a transaction defined by a standard, and a document based on a transaction having a non-standard definition;
select a set of second data components from one or more of the set of second documents;
generate a third document from the set of second data components wherein the third document is one of displayed to a user and reported in the form of a report; and
deliver the set of second documents and the third document to a set of destinations.

18. The computer usable program product of claim B17, wherein the document is an X.12 document, wherein a first data component in the set of first data components is one of a data element of the X.12 document and a data segment of the X.12 document.

19. The computer usable program product of claim B17, wherein the parsing, the identifying, the validating, the transforming, the selecting, and the generating is performed in accordance with a set of rules.

20. The computer usable program product of claim 19, wherein a rule for parsing in the set of rules comprises:
a specification of a data component, the specification including:
a rule identifier;
a data component identifier;
a data component attribute;
a directive to proceed to a second specification of a second data component based on a condition; and
a directive to proceed to a second rule based on a second condition.

21. The computer usable program product of claim 20, wherein each of the data component identifier and the rule identifier is a state in the processing of the document, wherein each of the directive to proceed to the second specification and the directive to proceed to the second rule is a state transition in the processing of the document.

22. The computer usable program product of claim 19, wherein a data component associated with the data component identifier in a specification may be located anywhere in the document.

23. The computer usable program product of claim 19, wherein a rule for transforming in the set of rules comprises:
an identification associated with the document;
an identification associated with the second document; and
a logic, wherein the logic is usable for determining a number of second documents present in the set of second documents, and one or more attributes of each second document in the set of second documents including one or more of a type of the second document and a destination of the second document.

24. The computer usable program product of claim 23, wherein a rule for sending in the set of rules comprises one or more of an indication of a method of communication to use with the destination of the second document, a fourth document to send to a source of the document, and a fifth document to receive from the destination of the second document.

25. The computer usable program product of claim 19, wherein a rule in the set of rules may apply to any combination of the parsing, identifying, validating, transforming, selecting, and generating.
